(19) United States
(12) Patent Application Publication
(10) Pub. No.: US 2009/0188285 A1
(43) Pub. Date: Jul. 30, 2009

(54) Auto lock system for bicycles

(75) Inventors: Yuan-Chih Cheng, Taichung County (TW); Chun-Hung Lin, Taichung City (TW)

Correspondence Address: CHENG, YUAN-CHIH, P.O.Box 44-2049, Taipei, 10668, TW

(73) Assignee: IDEAL BIKE CORP.

(21) Appl. No.: 12/010,573

(22) Filed: Jan. 28, 2008

(51) Int. Cl. B62H 5/00; E05B 71/00

(52) U.S. Cl. 70/233

(57) ABSTRACT

An auto lock system for bicycles includes a leveling detection member for detecting level status of the bicycle, a locking member for locking a rotational part of the bicycle, at least one detection member for detecting one of the rotational parts of the bicycle, and a control member which receives information from the leveling detection member and the at least one detection member so as to activate the locking member. The locking member can be installed to lock the front or rear wheels or the handlebar.

### BACKGROUND OF THE INVENTION

(1) Field of the Invention

The present invention relates to an auto lock system for bicycles and the system automatically locks the bicycle when the bicycle tilts an angle and the rotational parts are stationary and/or the kick stand is pivoted down.

(2) Description of the Prior Art

Generally, a conventional bicycle does not have a lock system as a vehicle which has a key so that the driver can lock the doors by using the key. The rider of a bicycle uses a bicycle lock which has to be operated after the bicycle is stopped and the conventional bicycle lock generally has to lock the wheel to a bicycle stand or a post. Often, the rider forgot to lock the bicycle or cannot find a suitable fixed object to lock with the bicycle.

The present invention intends to provide an auto lock system for bicycles, wherein the auto lock system is activated automatically when the bicycle tilts an angle. There are at least one detection member to detect the rotational parts of the bicycles to ensure that the auto lock system does not lock the bicycle when the bicycle is moving.

### SUMMARY OF THE INVENTION

The present invention relates to an auto lock system for bicycles and the system comprises a leveling detection member to detect level status of the bicycle, a locking member for locking a rotational part of the bicycle, at least one detection member for detecting one of detect rotational parts of the bicycle, and a control member for receiving information from the leveling detection member and the at least one detection member so as to activate the locking member.

The primary object of the present invention is to provide an automatically activation lock system for bicycles, and the system is activated when the bicycle tilts an angle and the rotational parts are stationary and the kick stand is kicked downward.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the flow chart of the auto lock system of the present invention;

FIG. 2 shows a bicycle with the auto lock system of the present invention;

FIG. 3 shows that the bicycle is not tilt and the locking member is not activated;

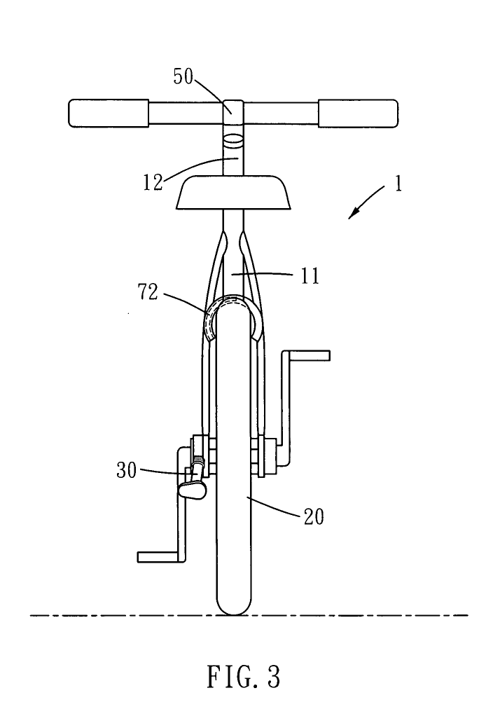

FIG. 4 shows that the bicycle tilts and moving, the auto lock system is not activated, and

FIG. 5 shows that the bicycle tilts and the kick stand is kicked downward, the auto lock system is activated.

### DETAILED DESCRIPTION OF THE PREFERRED EMBODIMENTS

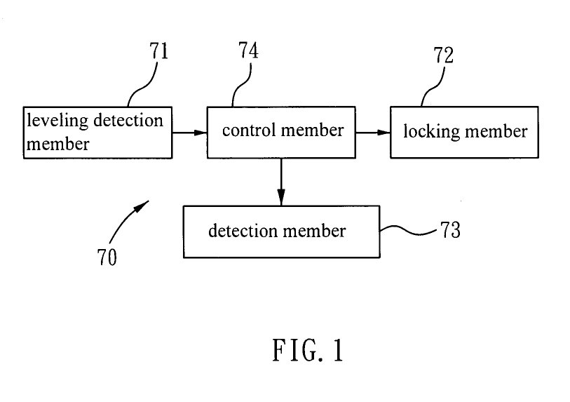

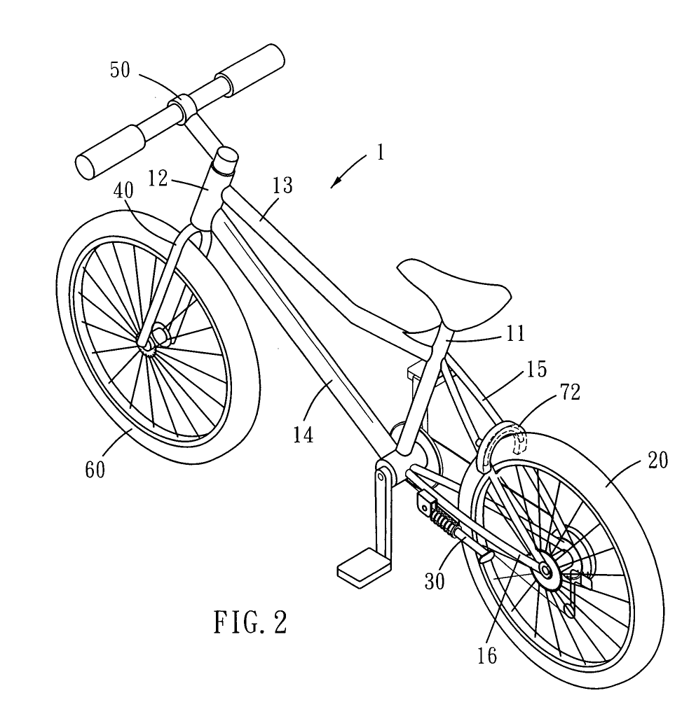

Referring to FIGS. 1 and 2, the bicycle 1 with the auto lock system 70 of the present invention comprises a head tube 12 with a top tube 13 and a down tube 14 connected thereto, a front fork 40 is rotatably inserted through the head tube 12 and is connected with a front wheel 60. A handlebar 50 is connected to a steeer tube connected with the front fork 40. A seat tube 11 is connected to two respective ends of the top tube 13 and the down tube 14, a bottom bracket is connected to a lower end of the seat tube 11 and a crank is connected to the bottom bracket, two pedals are connected to the tow ends of the crank. Down stays 15 and chain stays 16 are connected to the seat tube 11 and the bottom bracket, a rear wheel 20 is connected to conjunction portions of the down stays 15 and the chain stays 16. A kick stand 30 is pivotably connected to the chain stays 16.

The auto lock system 70 includes a leveling detection member 71, a locking member 72, at least one detection member 73 and a control member 74. The leveling detection member 71 can be a level instrument which is connected to the handlebar 50 or the seat so as to detect level status of the bicycle 1. The locking member 72 is connected to one of the rotational parts such as the front wheel 60, the rear wheel 20 of the handlebar 50. The locking member 72 is a U-shaped member and a latch is retractably received in the U-shaped case. The latch may insert between spokes of the front or rear wheels 60, 20.

The at least one detection member 73 detects one of rotational parts such as the front wheel 60, the rear wheel 20, the handlebar 50 and the kick stand 30. The control member 74 may be installed any portion of the bicycle 1 and receives information from the leveling detection member 71 and the at least one detection member 73 to activate the locking member 72.

As shown in FIG. 1, when the bicycle 1 is normally operated, the bicycle 1 does not tilt so that the leveling detection member 71 and the at least one detection member 73 do not send abnormal information to the control member 74, so that the locking member 72 is not activated.

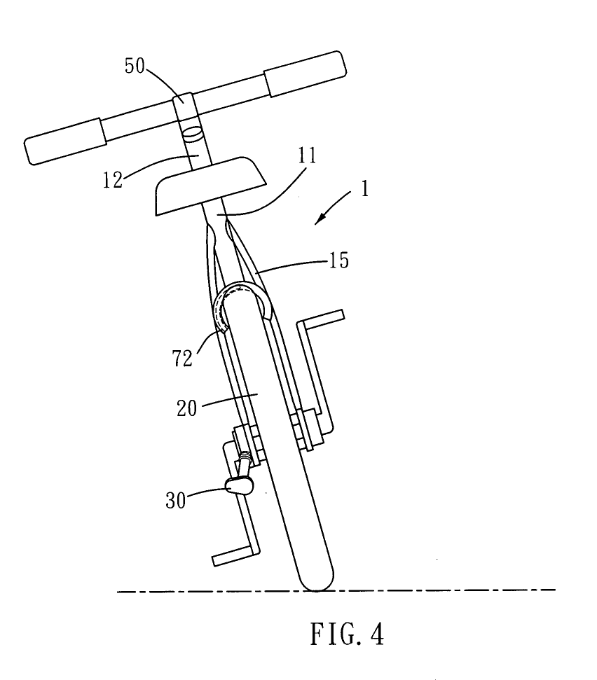

As shown in FIG. 4, when the bicycle 1 turns and tilts an angle, the leveling detection member 71 detects that the bicycle is tilt but the at least one detection member 73 detects that the rotational parts still rotate, so that the control member 74 judges the information from the leveling detection member 71 and the at least one detection member 73 and does not activate the locking member 72.

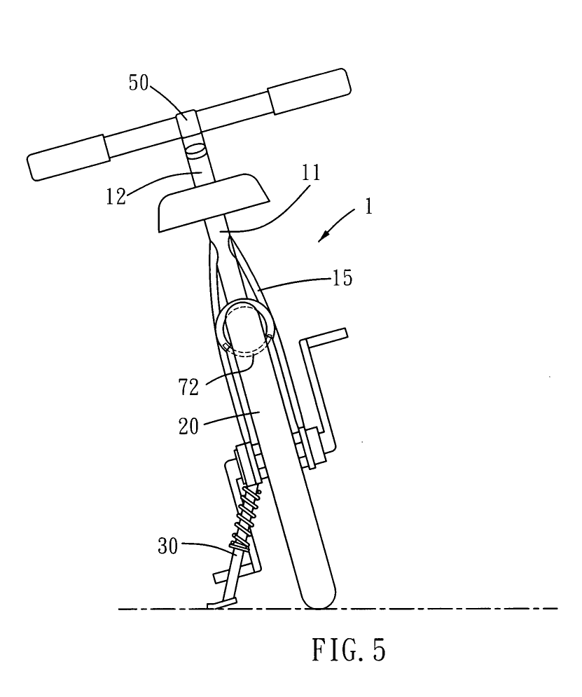

As shown in FIG. 5, when the bicycle 1 stops and the kick stand 30 is kicked downward, the leveling detection member 71 detects that the bicycle is tilt and the at least one detection member 73 detects that the rotational parts are stationary, so that the control member 74 judges the information from the leveling detection member 71 and the at least one detection member 73 and activates the locking member 72 to extend the latch of the locking member 72.

The auto lock system 70 can automatically lock the bicycle 1 without additional action from the rider, the auto lock system 70 also ensures that the moving bicycle 1 is not locked so that the rider can ride the bicycle safely.

While we have shown and described the embodiment in accordance with the present invention, it should be clear to those skilled in the art that further embodiments may be made without departing from the scope of the present invention.

What is claimed is:

1. An auto lock system for bicycles, comprising:
a leveling detection member adapted to detect level status of the bicycle;
a locking member adapted to lock a rotational part of the bicycle;
at least one detection member adapted to one of detect rotational parts of the bicycle, and
a control member receiving information from the leveling detection member and the at least one detection member to activate the locking member.

2. The system as claimed in claim 1, wherein the leveling detection member is a level instrument.

3. The system as claimed in claim 1, wherein the locking member includes a latch which is adapted to insert between spokes of wheels.

4. The system as claimed in claim 3, wherein the locking member is a U-shaped member and the latch is retractably received in a case.
